(19) United States
(12) Patent Application Publication
(10) Pub. No.: US 2020/0400282 A1
(43) Pub. Date: Dec. 24, 2020

(54) Lighting Device for a Motor Vehicle

(71) Applicant: Bayerische Motoren Werke Aktiengesellschaft, Munich (DE)

(72) Inventors: Helmut ERDL, Flintsbach (DE); Abdelmalek HANAFI, Muenchen (DE)

(21) Appl. No.: 16/968,447

(22) PCT Filed: Jan. 14, 2019
(86) PCT No.: PCT/EP2019/050733

§ 371 Date: Aug. 7, 2020

(30) Foreign Application Priority Data
Feb. 8, 2018 (DE) 10 2018 201 979.7

(51) Int. Cl. F21S 41/675; F21S 41/176; F21S 41/64

(52) U.S. Cl. CPC F21S 41/675; F21Y 2115/30; F21S 41/645; F21S 41/176

(57) ABSTRACT

A lighting device for a motor vehicle includes a light source and a spatial three-dimensional light modulator, on which light originating from the light source falls, wherein the three-dimensional light modulator can be activated electrically in order, during operation of the lighting device, to modulate the amplitude of the light falling thereon in such a way that a predefined light distribution is produced in the surroundings of the motor vehicle. Provided in the lighting device is a scanner, on which light originating from the light source falls and which is configured to carry out a scanning movement, such that a moving light beam which illuminates a predefined region on the three-dimensional light modulator is produced from the light which falls on the scanner.

### BACKGROUND AND SUMMARY OF THE INVENTION

The invention relates to a lighting device for a motor vehicle and a corresponding motor vehicle.

Installing spatial (3D) light modulators (SLM) in motor vehicle lighting systems is known from the prior art. Changeable light distributions can be generated in the vicinity of the motor vehicle by means of an amplitude modulation effected by these light modulators of the light that is incident thereon.

Even though spatial light modulators have a high spatial resolution, they lead to a decreased system efficiency, as they reduce the light amplitudes spatially dependently. In order to keep these losses low, it is known from the prior art to illuminate a spatial light modulator by means of a matrix-shaped light source made of a plurality of LEDs and switch off LEDs in dark regions of the light modulator in the process. The integration of matrix-shaped light sources in a motor vehicle lighting device is, however, technologically complex and correspondingly expensive.

The object of the invention is to provide a lighting device for a motor vehicle, with which a light distribution with high resolution can be generated easily and efficiently.

This object is achieved by means of the lighting device according to the claimed invention.

The lighting device according to the invention is provided for a motor vehicle, such as for example a passenger car and also, where appropriate, a truck. Preferably, the lighting device is an exterior light on the motor vehicle. In a preferred embodiment, the lighting device includes a front headlight or it is a front headlight, with which in particular at least one part of a dipped (low) beam light distribution and/or full (high) beam light distribution is generated. Nonetheless, the lighting device can possibly also represent another light on the motor vehicle, such as for example a taillight.

If interactions between the lighting device and the motor vehicle or components of the motor vehicle are described in the following and in particular in the patent claims, this should always be understood to the effect that the interaction occurs when the lighting device is arranged or installed in the motor vehicle. The components of the lighting device which have a corresponding interaction with the motor vehicle or structural components of the motor vehicle are thus embodied in such a way that the interaction is caused when the lighting device is arranged or installed in the motor vehicle.

The lighting device according to the invention comprises a light source and a spatial light modulator, on which light originating from the light source is incident. In a preferred embodiment the light source is a laser light source, which can comprise one or, possibly, a plurality of laser diodes. With a laser light source, light with a high luminance can be generated. Preferably, the power of the laser light source is between 3 W and 10 W. Nonetheless, another light source, such as for example an LED light source made of one or more LEDs, can also be used in the lighting device according to the invention if necessary. Preferably monochromatic light is generated with the light source.

The built-in spatial light modulator in the lighting device according to the invention is electrically actuatable to modulate the amplitude of light incident thereon during the operation of the lighting device in such a way that a specified light distribution is generated in the vicinity of the motor vehicle. In other words, the lighting device contains a control unit, which is embodied to electrically actuate the spatial light modulator in such a way that the specified light distribution is generated. Preferably, only the amplitude of the light that is incident thereon is modulated by the spatial light modulator.

The lighting device according to the invention is distinguished by virtue of a scanner being provided, on which light originating from the light source is incident and which is configured for implementing a scanning movement so that, from the light which is incident on the scanner, a moving light beam is formed, which illuminates a specified region on the spatial light modulator. The specified region is preferably a subregion of the surface of the spatial light modulator effecting the amplitude modulation. The scanner can, for example, be realized very compactly as an MEMS structural component (MEMS=micro electro mechanical system).

The lighting device according to the invention has the advantage that, due to the high spatial resolution which is achievable with the spatial light modulator, very fine patterns can be imaged in the light distribution in the vicinity of the motor vehicle. At the same time, a 2D light distribution can be generated on the light modulator easily and efficiently by using a scanner, without requiring a matrix-shaped light source therefor. In the process, the scanner performs the scanning movement of the corresponding light beam so quickly that its movement is not perceptible to the human eye, and so the impression of a continuously illuminated surface is formed.

In a particularly preferred embodiment, a so-called vector scanner is used as a scanner in the lighting device according to the invention, with which the scanning speed and scanning direction of the light beam can be set variably. Because of this, the region of the light modulator illuminated by the scanner can be varied as desired.

Depending on the embodiment, different spatial light modulators can be used in the lighting device according to the invention. In one variant, the spatial light modulator is a transmissive light modulator which is in particular realized as an LCD modulator (LCD=liquid crystal display). Alternatively or additionally, a reflective light modulator can be provided, which is preferably a DMD modulator (DMD=digital mirror device). The modulators just described are sufficiently well known to the person skilled in the art.

In a further preferred embodiment, the spatial light modulator is arranged in an intermediate image plane, in which a real intermediate image is generated by means of the moving light beam, from which the specified light distribution is generated in the vicinity of the motor vehicle by means of a secondary optical unit, which is a constituent part of the lighting device. With this embodiment, a simple and compact structure of the lighting device according to the invention is achieved. Depending on the embodiment, the above-described secondary optical unit can comprise one or more reflectors and/or one or more lenses.

In a particularly preferred embodiment, the lighting device according to the invention is embodied in such a way that a specified light form is generated on the spatial light modulator by means of the moving light beam, wherein during the operation of the lighting device, the spatial light modulator is actuated in such a way that the light form is clipped by the spatial light modulator. Thus, the spatial resolution of a light form generated with the scanner can be increased in an easy way using the spatial light modulator.

In a further preferred embodiment, a conversion element is provided in the lighting device according to the invention, said conversion element converting light from the light source that is incident thereon into white light, whereby a white light distribution is generated as a specified light distribution in the vicinity of the motor vehicle. Preferably, the conversion element is arranged upstream of the light modulator in the beam path of the light. In a particularly preferred variant, the conversion element is positioned at and in particular on the light modulator. This achieves a compact structure of the lighting device.

In a further variant, the lighting device according to the invention is configured to generate a base light distribution in the vicinity of the motor vehicle, which preferably is generated by a separate light module with a different light source to the one described in the above. The base light distribution is overlaid with the above-described light distribution in the process, wherein this light distribution is brighter than the base light distribution. In this way, particular light effects can be generated in the base light distribution. For example, a guide light, which stands out against the base light distribution, can be generated for driver assistance.

Besides the above-described lighting device, the invention relates to a motor vehicle which comprises one or more lighting devices according to the invention or preferred variants of these lighting devices.

An exemplary embodiment of the invention is described in detail below with the aid of the FIGURE.

### BRIEF DESCRIPTION OF THE DRAWING

FIG. 1 shows an embodiment of a lighting device according to the invention in a schematic sectional view.

### DETAILED DESCRIPTION OF THE DRAWING

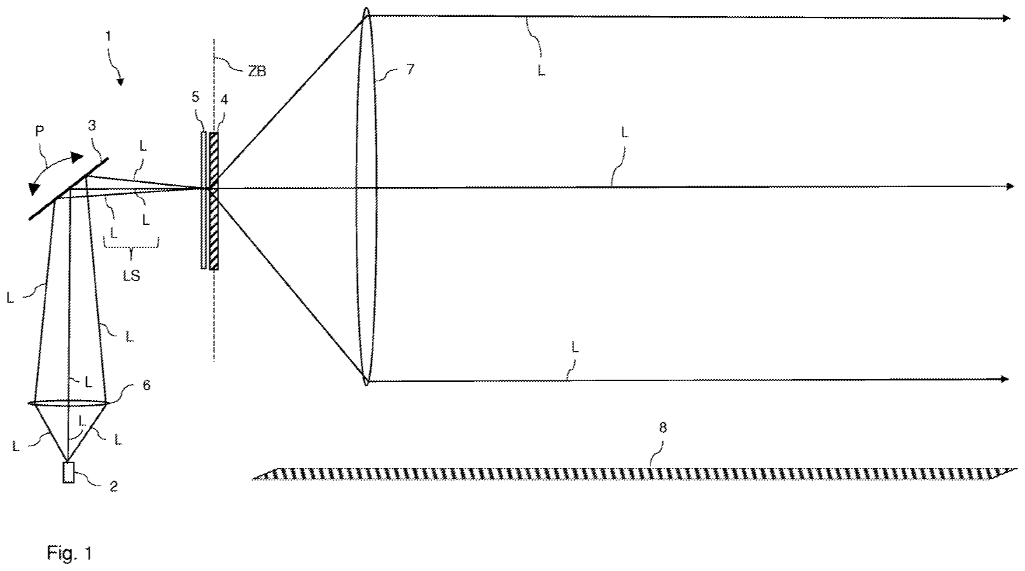

The invention is explained in exemplary fashion with the aid of a lighting device in the form of a front headlight of a motor vehicle. This front headlight is reproduced only schematically in FIG. 1 and designated by reference sign 1. For reasons of clarity, the housing of the front headlight and its transparent cover pane, via which the light from the headlight emerges from the housing, are omitted.

The front headlight 1 comprises a light source 2, which is a monochromatic laser light source, which generates for example blue laser light, in the embodiment described here. For this purpose, the laser light source comprises one or, possibly, a plurality of laser diodes. In FIG. 1, the beam path of the laser light is indicated by a plurality of continuous lines L, which for example represent the paths of corresponding light beams through the lighting device. The light of the laser light source 2 is collimated by a lens 6 and cast onto a scanner 3, which comprises a tiltable micromirror and is realized as an MEMS structural component in the embodiment described here.

The scanner 3 is an electrically actuatable vector scanner, the micromirror of which is both pivotable (indicated by the arrow P) about an axis lying perpendicular to the plane of the sheet in FIG. 1 and tiltable about an axis which lies parallel to the plane of the sheet in FIG. 1 and extends along the plane of the micromirror. The scanner 3 deflects the laser light of the laser light source 2 that is incident thereon and thus generates a light beam LS, which results from the reflection of the laser light at the micromirror and is moved by tilting or pivoting the mirror. Here, the scanning speed and the scanning direction of the light beam LS are variably settable by means of the vector scanner 3.

The light beam LS generated by the scanner 3 is incident on a unit made of a spatial light modulator 4 and a conversion element 5 arranged upstream thereof. In the embodiment described here, the spatial light modulator 4 is a transmissive light modulator in the form of an LCD modulator, which effects a variation or modulation of the amplitude of the light that is incident thereon. The conversion element 5 converts the monochromatic light beam LS that is incident thereon into white light, which subsequently passes the LCD modulator. The conversion element consists of conversion material known per se. For example, a phosphor conversion layer made of nitride phosphor or oxynitride phosphor or cerium-doped YAG phosphor is used for a blue/violet laser light source with an emission wavelength of 450 nm/405 nm.

The light modulator 4 is arranged in an intermediate image plane ZB, in which a real intermediate image is generated by means of the moving light beam LS, which image is optically imaged by means of a secondary optical unit, which represents a projection lens 7 in the embodiment in FIG. 1, in order to generate a specified light distribution on the road 8 in front of the front headlight. A part of the area of the light modulator which is opaque due to the amplitude modulation, is not located in the region of the intermediate image illuminated by the light beam.

Different light distributions can be generated by means of electrically actuating the scanner 3 and the LCD modulator 4, depending on the activated light function of the front headlight. For example, a specified light/dark boundary can be generated in a dipped beam light distribution by means of the light modulator 4 using a suitable spatially dependent reduction of the light amplitude. For this purpose, a 2D luminous surface, which is generated by quickly scanning the light beam LS over the light modulator 4, is suitably clipped by the light modulator. On account of the high spatial resolution of the light modulator in the region of 20 μm, very fine patterns can be generated in the light distribution. This is not possible when only using a scanner, because a relatively large light spot with a size between 100 μm and 300 μm is formed by the built-in conversion element 5.

In a development of the above-described lighting device, an additional light source generates a base light distribution on the road 8, which is overlaid with the light distribution generated by the light modulator and the secondary optical unit. Here, the light distribution originating from the light modulator is brighter than the base light distribution. In this way, special patterns for driver assistance can be imaged in a dipped beam or a full beam, such as for example a guide light, which indicates the future road path.

The previously described embodiments of the invention have a number of advantages. In particular, the possibility of generating a high-resolution light distribution and, in the process, simultaneously keeping the light losses low is provided, by means of the combination according to the invention of a scanner and a spatial light modulator. By means of the spatial light modulator, an absorption of the amplitude of the light that is incident thereon can be matched exactly to desired regions. In particular, sharp edges of the light distribution can be generated for increased contrast. Due to the high resolution of the spatial light modulator, the light absorption can thus be precisely restricted, and the efficiency losses can be greatly minimized or very restricted locally. Furthermore, by using a scanner, the light of the light source of the lighting device is used efficiently, without needing to use matrix-shaped light sources, which are only realized with great technological effort.

### LIST OF REFERENCES SIGNS

1 lighting device
2 light source
3 scanner
4 spatial light modulator
5 conversion element
6, 7 lenses
8 road
L light beams
ZB intermediate image plane
P double-ended arrow

1.-11. (canceled)

12. A lighting device for a motor vehicle, comprising:
a light source;
a spatial light modulator; and
a scanner, on which light originating from the light source is incident and which is configured for implementing a scanning movement so that, from the light which is incident on the scanner, a moving light beam is formed, which illuminates a specified region on the spatial light modulator; wherein
the spatial light modulator is electrically actuatable to modulate an amplitude of the light incident thereon during operation of the lighting device such that a specified light distribution is generated in a vicinity of the motor vehicle.

13. The lighting device according to claim 12, wherein
the light source comprises a laser light source.

14. The lighting device according to claim 12, wherein
the scanner is a vector scanner with variable scanning speed and scanning direction of the light beam.

15. The lighting device according to claim 12, wherein
the spatial light modulator comprises a transmissive modulator and/or a reflective modulator.

16. The lighting device according to claim 15, wherein
the transmissive modulator is an LCD modulator and the reflective modulator is a DMD modulator.

17. The lighting device according to claim 12, wherein
the spatial light modulator is arranged in an intermediate image plane, in which a real intermediate image is generated by the moving light beam, from which the specified light distribution is generated in the vicinity of the motor vehicle by a secondary optical unit.

18. The lighting device according to claim 17, wherein
the secondary optical unit comprises one or more reflectors and/or one or more lenses.

19. The lighting device according to claim 12, wherein
a specified light form is generated on the spatial light modulator by the moving light beam, wherein, during the operation of the lighting device, the spatial light modulator is actuated such that the light form is clipped by the spatial light modulator.

20. The lighting device according to claim 12, further comprising:
a conversion element in the lighting device, said conversion element converting the light of the light source that is incident thereon into white light, whereby a white light distribution is generated as a specified light distribution in the vicinity of the motor vehicle.

21. The lighting device according to claim 12, wherein
the lighting device comprises a front headlight for a motor vehicle, and
the lighting device is configured to generate at least one part of a dipped beam light distribution and/or full beam light distribution as a light distribution in the vicinity of the motor vehicle.

22. The lighting device according to claim 12, wherein
the lighting device is configured to generate a base light distribution in the vicinity of the motor vehicle, which is overlaid with the specified light distribution, wherein the specified light distribution is brighter than the base light distribution.

23. A motor vehicle comprising one or more lighting devices according to claim 12.
